(19) United States
(12) Patent Application Publication
(10) Pub. No.: US 2004/0030961 A1
(43) Pub. Date: Feb. 12, 2004

(54) Method for informing error codes of disk drive

(76) Inventors: Chien-Chun Ma, Taipei (TW); Jen-Yu Hsu, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/292,612

(22) Filed: Nov. 12, 2002

(30) Foreign Application Priority Data
Aug. 6, 2002 (TW) 91117719

(51) Int. Cl. H04B 1/74

(52) U.S. Cl. 714/42

(57) ABSTRACT

The present invention discloses a method for informing error codes of a disk drive. First, microcontroller detects any events of drive failures. Next, when one event is detected, an error message corresponding to the detecting event is implied by using movable parts or lighting elements of the disk drive. In this way, the support personnel can easily ascertain the nature of the disk failure and provide the corresponding solution to the user according to the error messages explained by the user.

### BACKGROUND OF THE INVENTION

1. Field of the Invention

The present invention relates in general to a method for informing error codes of a disk drive. In particular, the present invention relates to communicating specific messages corresponding to the events of drive failures by using the movable parts or lighting elements of the disk drive.

2. Description of the Related Art

When a CD-ROM drive fails, the disk failure can only be informed by using some debugging tools. Therefore, users may not be able to ascertain the causes of the failure. Moreover, the department of customer service often receives calls questioning malfunctions of CD-ROM drive. Since the CD-ROM drive is not equipped with any debugging tools to diagnose its operating conditions, reasons for failures cannot be instantly provided to the users. If certain signals are informed by the CD-ROM drive, the department of customer service would be able to determine the reasons for failures directly from the signals given by the CD-ROM drive that described by the users.

### SUMMARY OF THE INVENTION

The object of the present invention is to provide a method for informing error codes of a disk drive to users. Error codes are implied by using the movable parts or lighting elements of the disk drive, such as blinking the lighting elements a specific times, opening and closing of the loading tray, start/stop cycles of the motor and optical head movement, or any combination thereof. Users can provide the error codes given by the disk drive to support personnel as needed, who can then use the codes to determine failure causes.

To achieve the above-mentioned object, the present invention provides a method for informing error codes of a disk drive by using moveable parts or lighting elements of the disk drive. First, any events of disk failure are detected. Next, when one event of disk failures is detected, the disk drive communicates an error message corresponding to the event of disk failure by using movable parts or lighting elements of the disk drive.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a structural diagram of the disk drive according to the embodiment of the present invention.

FIG. 2 is a flowchart of the operation process according to the embodiment of the present invention.

### DETAILED DESCRIPTION OF THE INVENTION

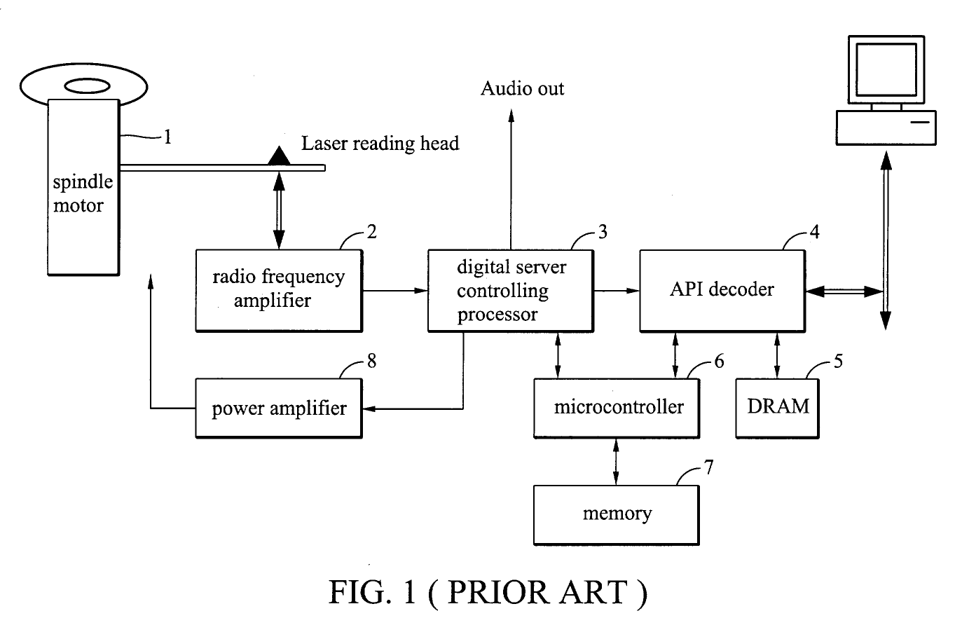

FIG. 1 is a structural diagram of the disk drive according to the embodiment of the present invention. The disk drive according to the embodiment comprises a spindle motor 1, a radio frequency amplifier 2, a digital server-controlling processor 3, an application program interface (API) decoder 4, a dynamic random access memory (DRAM) 5, microcontroller 6, memory 7, and power amplifier 8. Since the functions and relations between each elements of the disk drive are not related to the present invention, the introduction of the elements is omitted to simplify the description.

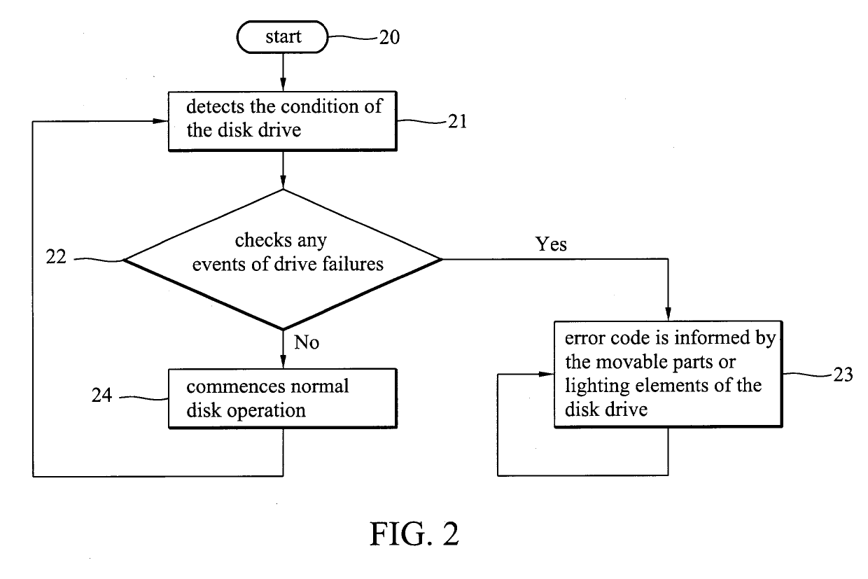

FIG. 2 is a flowchart of the operation process according to the embodiment of the present invention. First, the disk drive is started (20). Next, the microcontroller of the disk drive detects the condition of the disk drive (21), and checks for any events of drive failures (22). Here, the detection is performed by microcontroller executing the program stored in the memory.

If the determination in step 22 is yes, an error code is informed by the movable parts or lighting elements of the disk drive (23). The movable parts of the disk drive can be the loading tray, spindle motor or the optical head. If there is no disk failure detected by the microcontroller, normal disk operation commences (24) and the flow goes back to step 21.

According to the embodiment of the present invention, the disk drive performs specific movements corresponding to the event of disk failure. For example, when the microcontroller of the disk drive detects the disk failure in the DRAM, the disk drive performs a predetermined movement to inform the event of disk failure. The predetermined movement of the disk drive can involve blinking the lighting elements a constant times or frequency, opening and closing of the loading tray, start/stop a constant cycles of the motor or optical head movement, or any combination thereof. Thus, it can be understood what event of disk failure has occurred.

Thus, the user can discover the condition of the disk drive according to the error messages communicated by the various elements controlled by the microcontroller of the disk drive and explain the condition of the disk drive clearer. In turn, support personnel can easily ascertain the nature of the disk failure and provide the corresponding solution to the user according to the error messages explained by the user.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is

1. A method for informing error codes of a disk drive, comprising the steps of:
detecting any events of drive failures; and
communicating an error message corresponding to one of said events, when one of said events is detected;
wherein, said error message is implied by using one of movable parts or one of lighting elements of said disk drive.

2. The method for informing error codes of the disk drive as claimed in claim 1, wherein said step of detecting any events of drive failures is performed by a microcontroller executing a program stored in a memory.

3. The method for informing error codes of the disk drive as claimed in claim 1, wherein said movable parts are a loading tray, a spindle motor, or an optical head.
